(19) United States
(12) Patent Application Publication
(10) Pub. No.: US 2018/0172073 A1
(43) Pub. Date: Jun. 21, 2018

(54) HYDRAULIC BEARING

(71) Applicant: Carl Freudenberg KG, Weinheim (DE)

(72) Inventor: Detlef Cordts, Wandlitz (DE)

(21) Appl. No.: 15/736,299

(22) PCT Filed: Jun. 24, 2016
(86) PCT No.: PCT/EP2016/064635

§ 371 Date: Dec. 14, 2017

(30) Foreign Application Priority Data
Jun. 29, 2015 (DE) 102015008224.8

(51) Int. Cl. F16C 32/06; B61F 15/26

(52) U.S. Cl. CPC F16C 32/0659; F16C 2326/10; B61F 15/26

(57) ABSTRACT

In an embodiment, the present invention provides a bearing for use in a rail vehicle, including: a core assembly; a casing assembly that surrounds said core assembly, the core assembly being supported against the casing assembly by at least one membrane and being movable relative to the casing assembly; and a functional chamber, which chamber contains a working fluid, the functional chamber being delimited by a pumping surface that is formed by the core assembly and the membrane. A projection surface of the pumping surface that is orthogonal to an axial direction covers between 60% and 99% of a cross-sectional area, orthogonal to the axial direction, of the interior of the casing assembly, in which the membrane and the core assembly are received at least in part.

### CROSS-REFERENCE TO PRIOR APPLICATIONS

This application is a U.S. National Phase application under 35 U.S.C. § 371 of International Application No. PCT/EP2016/064635, filed on Jun. 24, 2016, and claims benefit to German Patent Application No. DE 10 2015 008 224.8, filed on Jun. 29, 2015. The International Application was published in German on Jan. 5, 2017 as WO 2017/001292 under PCT Article 21(2).

### FIELD

The invention relates to a bearing.

### BACKGROUND

Hydraulic bearings which comprise a core assembly and a casing assembly that surrounds said core assembly are known from the prior art. In this case, the core assembly is supported against the casing assembly by means of at least one elastomer or a plurality of elastomers and is movable relative to said casing assembly. Elastomers of this kind are also referred to as membranes. The bearings usually comprise functional chambers in which working fluids are received.

The stiffness of such bearings is defined by a force per distance. The bearings have static stiffnesses that are determined by the elastomers and the functional chambers. The bearings also have dynamic stiffnesses that are usually significantly greater than the static ones. There is therefore often what is known as a stiffness discontinuity between a static stiffness and a dynamic stiffness.

### SUMMARY

In an embodiment, the present invention provides a bearing for use in a rail vehicle, comprising: a core assembly; a casing assembly that surrounds said core assembly, the core assembly being supported against the casing assembly by at least one membrane and being movable relative to the casing assembly; and a functional chamber, which chamber contains a working fluid, the functional chamber being delimited by a pumping surface that is formed by the core assembly and the membrane, wherein a projection surface of the pumping surface that is orthogonal to an axial direction covers between 60% and 99% of a cross-sectional area, orthogonal to the axial direction, of the interior of the casing assembly, in which the membrane and the core assembly are received at least in part.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a perspective partial cross section of a bearing comprising a large movable pumping surface, and

FIG. 2 is a perspective view of the bearing according to FIG. 1.

### DETAILED DESCRIPTION

It has been found, according to the invention, that a particularly large stiffness discontinuity can be achieved by a pumping surface, specifically a surface to which the working fluid can be applied in such a way as to bring about movement, that is as large as possible, and a membrane that is extremely supple in the movement direction.

The pumping surface is a surface to which the working fluid can be applied in such a way as to bring about movement. Since the pumping surface is formed not only by the stiff core assembly, but also by the resilient membrane, the size of the pumping surface changes as the core assembly is deflected. This is due to the fact that the membrane is stretched in regions. However, some regions of the membrane also remain unstretched, specifically the regions that are too far from the periphery of the pumping surface and/or are too stiff to be substantially expanded. Within the meaning of this invention, the term pumping surface therefore also refers to a surface, in the undeflected state of the core assembly, to which force could possibly be applied and/or which is possibly movable. The projection surface thereof is always smaller than the actual effective pumping surface, since the pumping surface also comprises elevations and unevenness.

The projection surface could have a radius that is smaller than half the inner diameter of the interior of the casing assembly. The radius of the projection surface is therefore smaller than the radius of the cross-sectional area of the interior of the casing assembly that is orthogonal to the axial direction. This is due to the fact that the membrane is connected to the casing assembly by a bead which cannot contribute to the pumping surface on account of the immovability or stiffness thereof.

The interior of the casing assembly could be cylindrical. The membrane can thus be oriented in a plane, formed as a ring and vulcanized onto the casing assembly and the core assembly.

Against this background, the membrane could be vulcanized onto an annular surface of the inside wall of the casing assembly. As a result, the membrane occupies relatively little space between the casing assembly and the core assembly.

The bearing may have a dynamic stiffness in the range of from 8 kN/mm to 16 kN/mm. As a result, the bearing is particularly suitable for use in rail vehicles. An admission pressure in the system can cause particularly high dynamic stiffnesses until a specific deflection of the core assembly has been achieved.

Against this background, the core assembly could be deflectable relative to the casing assembly, in the axial direction, by a travel distance from the rest position, the travel distance being in the range of from 6 to 14 mm. These travel distances can be achieved by an optimized rubber membrane.

It is possible that the core assembly could be deflectable in two directions, specifically in two opposing directions, by the travel distance. The bearing can thus be inserted into the axle region of a rail vehicle.

The bearing described here is preferably used in rail vehicles.

The bearing described here can be operated both passively, without external control, and actively, by means of external hydraulic control.

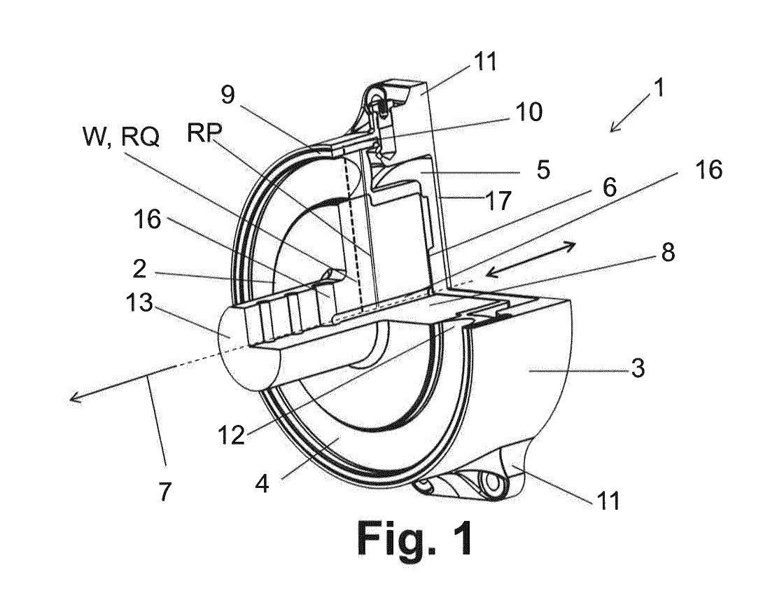

FIG. 1 shows a bearing 1 for use in a rail vehicle, comprising a core assembly 2 and a casing assembly 3 that surrounds said core assembly, the core assembly 2 being supported against the casing assembly 3 by means of at least one membrane 4 and being movable relative to the casing assembly 3, a functional chamber 5 being provided, which chamber contains a working fluid, and the functional chamber 5 being delimited in part by a movable pumping surface 6 that is formed by the core assembly 2 and the membrane 4.

In the rest position, a projection surface of the pumping surface 6 that is orthogonal to the axial direction 7 covers between 80% and 99% of the cross-sectional area, orthogonal to the axial direction 7, of the interior 8 of the casing assembly 3, in which the membrane 4 and the core assembly 2 are received at least in part. In the rest position, the core assembly 2 is not deflected and the pumping surface 6 is unmoved.

The above-mentioned projection surface of the pumping surface 6 has a radius RP that is smaller than half the inner diameter W of the interior 8 of the casing assembly 3. This is due to the fact that the membrane 4 is connected to the casing assembly 3 by a bead 9 which cannot contribute to the pumping surface 6 on account of the immovability or stiffness thereof.

The radius RP of the projection surface of the pumping surface 6 is therefore smaller than the radius RQ of the cross-sectional area of the interior 8 of the casing assembly 3 that is orthogonal to the axial direction 7. The radius RQ of the cross-sectional area of the interior 8 that is orthogonal to the axial direction 7 corresponds to half the inner diameter W of the interior 8.

In the specific embodiment, the cross-sectional area of the interior 8 of the casing assembly 3, specifically a circular area, is approximately 41547 mm². In this case, the pumping surface 6 is approximately 34636 mm³. In this respect, the pumping surface 6 occupies 83.4% of the above-mentioned cross-sectional area. The smaller the pumping surface 6, the lower the dynamic stiffness and/or the ratio of the dynamic to static stiffness of the bearing 1 under otherwise the same conditions. The bearing 1 has a dynamic stiffness in the range of from 8 kN/mm to 16 kN/mm.

The interior 8 of the casing assembly 3 is cylindrical. The membrane 4 is vulcanized onto an annular surface of the inside wall 10 of the casing assembly 3. The membrane 4 is made of rubber.

The core assembly 2 is deflectable relative to the casing assembly 3, in the axial direction 7, and by a travel distance from the rest position, the travel distance being in the range of from 6 to 14 mm. The core assembly 2 is deflectable in two directions, by the relevant travel distance. This is illustrated by the double arrow. The two directions oppose one another.

The membrane 4 is concave in the axial direction 7, specifically in the direction of a protruding pin 13 of the core assembly 2. Specifically, the membrane 4 comprises a fully peripheral hollow 12. The hollow 12 is U-shaped or V-shaped.

In FIG. 1, the bearing 1 is formed as an active bearing having hydraulic control, but this does not limit the generality. A fluid channel 16 is provided, via which working fluid can be introduced into the functional chamber 5. Working fluid is thus applied to the functional chamber 5, which is closed by a cover 17. The incompressible working fluid then presses against the pumping surface 6 and thus deflects the core assembly 2 in the axial direction 7. The above-described deflection can be reversed by removing the working fluid from the functional chamber 5.

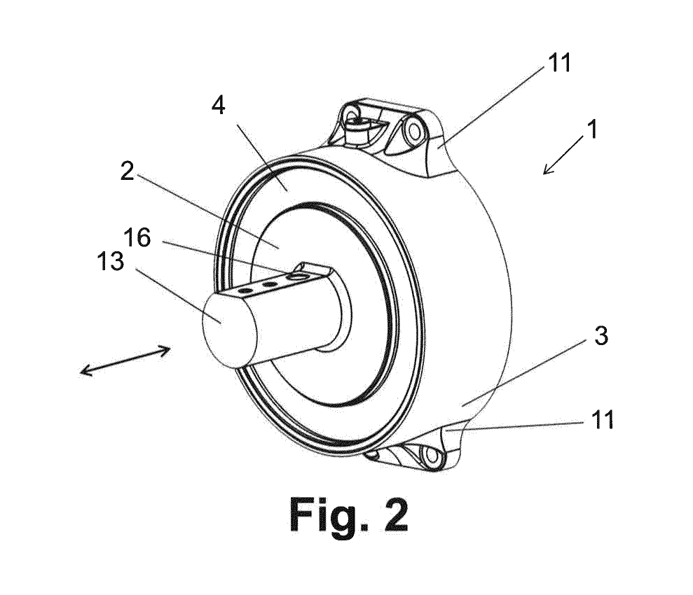

FIG. 2 is a perspective view of the bearing 1. Specifically, two flanges 11 are shown, which each comprise two passages, are diametrically opposed to one another, and are arranged on the casing assembly 3. The bearing 1 can thus be screwed onto an existing arrangement, in particular in the axle region of a rail vehicle.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A bearing for use in a rail vehicle, comprising:
a core assembly; and
a casing assembly that surrounds said core assembly, the core assembly being supported against the casing assembly by means of at least one membrane and being movable relative to the casing assembly; and
a functional chamber, which chamber contains a working fluid, the functional chamber being delimited by a pumping surface that is formed by the core assembly and the membrane,
wherein
a projection surface of the pumping surface that is orthogonal to an axial direction covers between 60% and 99% of a cross-sectional area, orthogonal to the axial direction, of the interior of the casing assembly, in which the membrane and the core assembly are received at least in part.

2. The bearing according to claim 1, wherein the projection surface has a radius that is smaller than half an inner diameter of the interior of the casing assembly, specifically smaller than a radius of the cross-sectional area of the interior of the casing assembly that is orthogonal to the axial direction.

3. The bearing according to claim 1, wherein the interior of the casing assembly is cylindrical.

4. The bearing according to claim 1, wherein the membrane is vulcanized onto an annular surface of an inside wall of the casing assembly.

5. The bearing according to claim 1, having a dynamic stiffness in the range of from 8 kN/mm to 16 kN/mm.

6. The bearing according to claim 1, wherein the core assembly is deflectable relative to the casing assembly, in the axial direction, and by a travel distance from a rest position, the travel distance being in the range of from 6 to 14 mm.

7. The bearing according to claim 6, wherein the core assembly is deflectable in two directions, by the travel distance.

8. Use of a bearing according to claim 1 in a rail vehicle.

9. The bearing according to claim 1, wherein the projection surface covers between 70% and 99% of the cross-sectional area.

10. The bearing according to claim 9, wherein the projection surface covers between 80% and 99% of the cross-sectional area.

11. The bearing according to claim 10, wherein the projection surface covers between 90% and 99% of the cross-sectional area.
